(19) United States
(12) Patent Application Publication
(10) Pub. No.: US 2024/0195255 A1
(43) Pub. Date: Jun. 13, 2024

(54) ELECTRIC MACHINE

(71) Applicant: Schaeffler Technologies AG & Co. KG, Herzogenaurach (DE)

(72) Inventors: Michael Menhart, Igling (DE); Stefan Riess, Kaufering (DE); Johann Oswald, Eschenlohe (DE); Carsten Sonntag, Gauting-Konigswiesen (DE); Andrä Carotta, Munchen-Hadern (DE)

(73) Assignee: Schaeffler Technologies AG & Co. KG, Herzogenaurach (DE)

(21) Appl. No.: 18/554,563

(22) PCT Filed: Apr. 8, 2022
(86) PCT No.: PCT/DE2022/100264

§ 371 Date: Oct. 9, 2023

(30) Foreign Application Priority Data
Apr. 10, 2021 (DE) 102021108957.3

(51) Int. Cl. H02K 3/34; H02K 1/16; H02K 1/20

(52) U.S. Cl. CPC H02K 3/345; H02K 1/16; H02K 1/20

(57) ABSTRACT

An electric machine comprises a stator, a rotor and an air gap between the stator and the rotor. The stator includes a stator member, a stator winding, an insulating coating between the stator winding and the stator member to provide electric insulation between the stator winding and the stator member, and a local depression in the stator member. The insulating coating is disposed in the local depression. The local depression is located on a side of the stator member facing the air gap.

### CROSS-REFERENCE TO RELATED APPLICATIONS

This application is the U.S. National Phase of PCT Appln. No. PCT/DE2022/100264, filed Apr. 8, 2022, which claims the benefit of German Patent Appln. No. 102021108957.3, filed Apr. 10, 2021, the entire disclosures of which are incorporated by reference herein.

### TECHNICAL FIELD

The present disclosure relates to an electric machine, in particular an electric axial flux machine.

### BACKGROUND

An electric axial flux machine is known from WO 01/11755 A1, which has a disk-shaped rotor arranged on a shaft and two stators arranged coaxially to the rotor. The rotor has permanent magnets. The permanent magnets are connected to a surrounding plastic in an interlocking manner. Together with the permanent magnet and the shaft, the plastic forms a dimensionally stable unit.

In general, electric axial flux machines are known in different designs with one or more stators and one or more rotors.

An electric drive train is also known. The electric drive train has components for storing energy, converting energy, and conducting energy. The components for converting energy have an electric machine, for example an axial flux machine.

In such an electric machine, an insulating coating on the conductors, for example a copper wire, is used to insulate conductors of stator windings from a stator. Furthermore, an insulating paper can be used to line stator grooves in which the conductors are located. In this way, an insulating effect is maintained in the event of a fault in the insulating coating of the conductors, since the conductor exposed due to the fault is electrically insulated by the insulating paper from adjacent electrically conductive components of a different electrical potential, in particular the stator.

When using insulation paper, it is only possible to cover a single stator groove with a simple geometry. Three-dimensional geometries are difficult or impossible to cover. To maintain clearance and creepage distances and to compensate for manufacturing and positioning inaccuracies, the insulating paper protrudes from the stator groove on both sides by at least 2 to 4 mm, depending on the voltage level.

For a high power and torque density, it is necessary to maximize an electromagnetically active surface in an air gap of the electric machine in a given installation space. Since the air gap surface is cylindrical in electric radial flux machines and has a constant distance to a main axis of the electric radial flux machine, a protrusion of the insulating paper on both sides linearly reduces a power and torque density. In the case of axial flux machines, the air gap area is an annular area which is arranged around a main axis of the electric axial flux machine. Insulation paper protruding radially from a stator groove on both sides consequently reduces the electromagnetically active area quadratically and acts on a power density approximately to the third power. The protruding insulating paper significantly reduces the power density, particularly on an outer diameter of a stator of the electric axial flux machine.

### SUMMARY

It is accordingly the object of the present disclosure to create an electric machine, in particular an axial flux machine, in which an electromagnetically active surface is increased in an air gap within a predetermined installation space, without increasing the dimensions of the stator or the electric machine.

The object is achieved with the measures stated in the independent claim.

Further advantageous embodiments of the present disclosure are the subject of the dependent claims.

In one aspect, an electric machine has a stator, a rotor, and an air gap between the stator and the rotor. The stator has a stator body, a stator winding, an insulating coating arranged between the stator winding and the stator body for providing electric insulation between the stator winding and the stator body, and a local depression provided in the stator body. The insulating coating is arranged in the local depression. The local depression is arranged on a side of the stator body facing the air gap.

According to one embodiment, the insulating coating is arranged exclusively in the local depression on the side of the stator body that faces the air gap.

According to a further embodiment, the electric machine is designed as an electric axial flux machine and the stator and the rotor with the air gap located in between are arranged coaxially to one another in a direction axial to a main axis of the electric axial flux machine.

According to a further configuration, the local depression is formed such that, in the direction axial to the main axis, a common height of the stator body and the insulating coating arranged in the local depression is less than or equal to a height of the stator body outside a region of the local depression.

According to a further embodiment, the stator body has a stator tooth and a stator yoke, and the local depression is provided in the stator tooth.

According to a further embodiment, the insulating coating is provided on the stator yoke on a side of the stator yoke facing the air gap.

According to a further embodiment, the insulating coating is arranged directly on the stator.

According to a further embodiment, the insulating coating is provided on a side face of the stator tooth adjoining the stator yoke.

According to a further embodiment, between the insulating coating provided on the side face of the stator tooth adjoining the stator yoke and the stator winding, a spacer element is provided for forming a cooling channel between the insulating coating and the stator winding.

According to a further embodiment, the insulating coating is applied to the stator via lacquering or fluidized bed sintering or via overmolding of the stator, in particular via transfer molding or injection molding.

According to the aspect and its refinements, a compact electric machine is realized, in which the dimensions of the electric machine and the dimensions of the individual components are optimized or minimized.

More precisely, the electromagnetically active area is increased or maximized in order to increase a power density within a predetermined installation space of the electric machine. Likewise, a conventionally used insulating paper can be completely or at least partially dispensed with.

### BRIEF DESCRIPTION OF THE DRAWINGS

The present disclosure is explained in more detail below based on the description of an embodiment with reference to the accompanying drawing.

In the drawings:

FIG. 1 shows a schematic perspective view of an electric axial flux machine according to an embodiment;

FIG. 2 shows a schematic exploded view of the electric axial flux machine according to the embodiment;

FIG. 3 shows a schematic representation of a part of a stator body with a stator winding of the electric axial flux machine according to the embodiment;

FIG. 4 is a schematic sectional view of a region along a section B-B in FIG. 3 according to the embodiment; and

FIG. 5 is a schematic sectional view of a region along a section A-A in FIG. 3 according to the embodiment.

### DETAILED DESCRIPTION

Before going into the detailed description of the embodiment, it should be noted that although the embodiment shows an electric axial flux machine having two stators and a rotor located in between, the present disclosure is not limited to this embodiment. Rather, the present disclosure can be used on different types of electric axial flux machines and on different types of electric radial flux machines.

The electric machine of the present disclosure may be used in an electric drive train of a motor vehicle. The electric drive train has components for storing energy, converting energy, and conducting energy. The electric machine, for example in the form of an axial flux machine, has the components for converting energy.

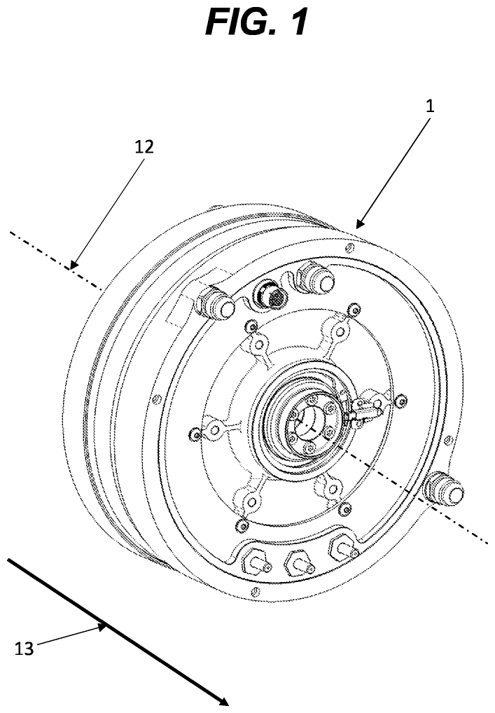

FIGS. 1 to 5 are schematic views of an electric axial flux machine according to the embodiment.

In FIGS. 1 to 5, reference sign 1 denotes the electric axial flux machine, reference sign 2 denotes a first stator, reference sign 3 denotes a stator body having a stator winding, reference sign 4 denotes a rotor, reference sign 5 denotes a second stator, reference sign 6 denotes a stator tooth, reference sign 7 denotes an insulating coating, reference sign 8 denotes the stator winding, reference sign 9 denotes a housing, reference sign 10 denotes a stator yoke, reference sign 11 denotes a local depression, reference sign 12 denotes a main axis, reference sign 13 denotes an axial direction, reference sign 14 denotes an air gap, and reference sign 15 denotes a spacer element.

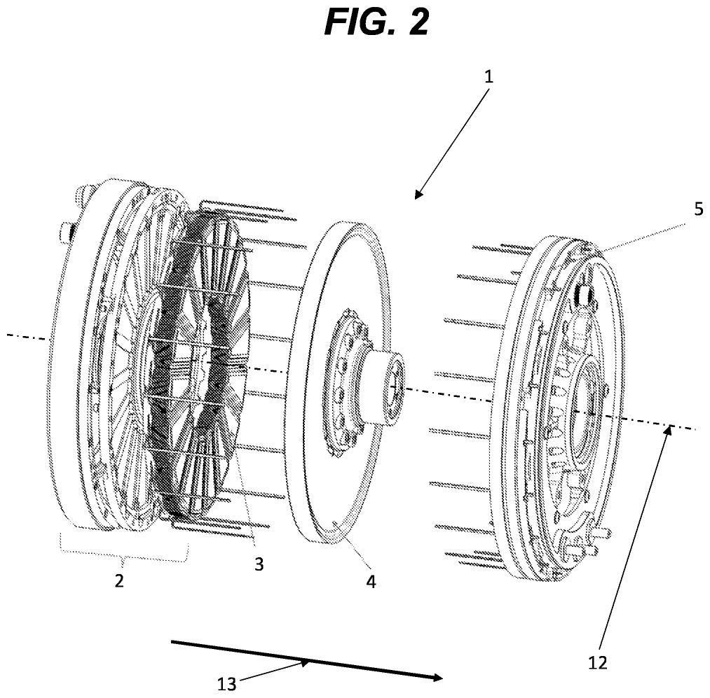

Referring to FIGS. 1 and 2, FIG. 1 shows a schematic perspective view of the electric axial flux machine 1 according to the embodiment, and FIG. 2 shows a schematic exploded view of the electric axial flux machine 1 according to the embodiment.

The electric axial flux machine 1 has a main axis 12. The main axis 12 is an axis about which the rotor 4 of the electric axial flux machine 1 rotates and about which the first stator 2 and the second stator 5 are arranged substantially concentrically. The axial direction 13 is a direction that is axial to the main axis 12.

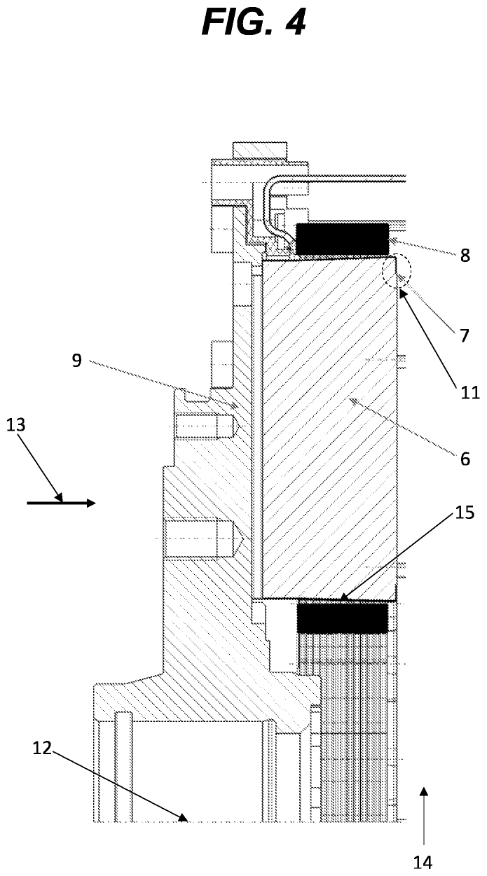

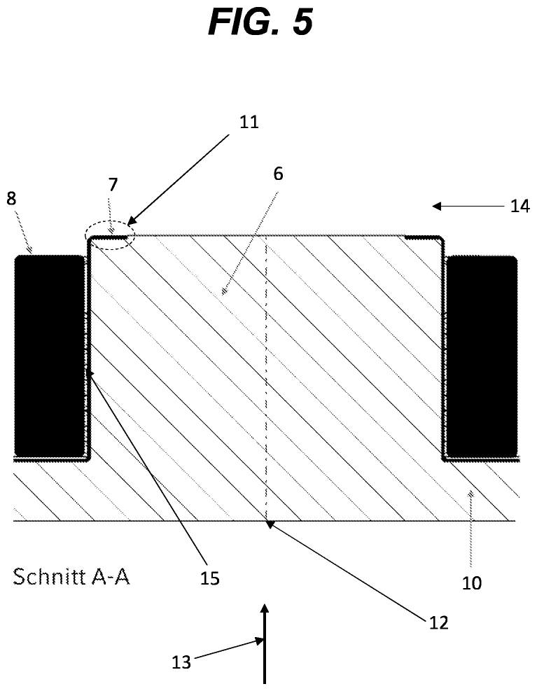

The first stator, the second stator 5 and the rotor 4 are arranged coaxially with one another in a direction axial to the main axis 12 of the electric axial flow machine 1 with the air gap 14 shown in FIGS. 4 and 5 located in between.

Each of the first stator 2 and the second stator 5 has a respective stator body 3 on which a respective stator winding 8 is situated. Each respective stator body 3 has a plurality of stator teeth 6 and a stator yoke 10 as shown in FIG. 5. The respective stator windings 8 are formed from one or more electrical conductors, around which an electric insulation layer is provided for electric insulation of the electrical conductors from the environment.

For the sake of simplicity, only one stator is assumed here below, wherein the following explanations apply to at least one of the first stator 2 and the second stator 5.

Furthermore, only one stator tooth 6 is assumed below, wherein the following explanations apply to at least one of several stator teeth of both the first stator 2 or the second stator 5, as well as the first stator 2 and the second stator 5.

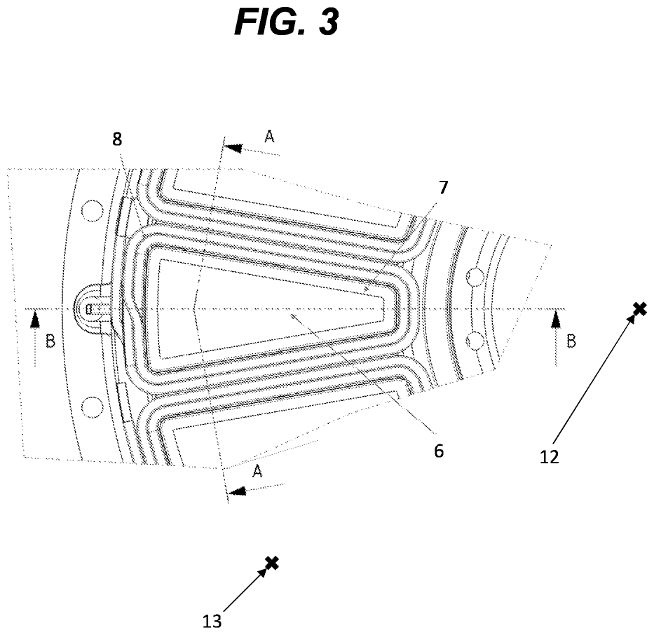

Reference is made to FIG. 3, wherein FIG. 3 shows a schematic representation of a part of the stator body 3 with the stator winding 8 of the electric axial flux machine 1 according to the embodiment.

The stator winding 8 is wound around the stator teeth 6 in a radial direction of the stator and a circumferential direction of the stator.

An insulating coating 7 is arranged between the stator winding 8 and the stator tooth 6 in order to provide electric insulation between the stator winding 7 and the stator tooth 6.

Referring to FIGS. 4 and 5, FIG. 4 shows a schematic sectional view of a region along a section B-B in FIG. 3 according to the embodiment, and FIG. 5 shows a schematic sectional view of a region along a section A-A in FIG. 3 according to the embodiment.

The stator or the stator tooth 6 is coupled or connected in a non-rotatable manner to the housing 9 which is, for example, a housing of the electric axial flux machine 1.

The stator tooth 6 has a local depression 11 in which an insulating coating 7 is arranged. The local depression 11 is provided on a side of the stator tooth 6 facing the air gap 14. This means that the local depression faces the rotor 4 across the air gap 14.

The local depression 11 is formed in such a way that in the axial direction 13, i.e., the direction axial to the main axis (12), a common height of the stator body or stator tooth 6 and the insulating coating 7 arranged in the local depression 11 is preferably less than or is equal to a height of the stator body or stator tooth 6 outside a region of the local depression 11.

In addition to the provision of the insulating coating 7 on the side of the stator tooth 6 facing the air gap 14, the insulating coating 7 can be provided on the stator yoke 10 on a side of the stator yoke 10 facing the air gap 14.

Furthermore, the insulating coating 7 can be provided on a side face of the stator tooth 6 adjoining the stator yoke 10.

The insulating coating 7 can also be arranged directly on the stator.

In order to allow the stator winding 8 to be cooled by means of a cooling fluid, for example a cooling oil, a spacer element 15 can be provided for forming a cooling channel between the insulating coating 7 and the stator winding 8. The spacer element 15 is preferably provided between the insulating coating 7 provided on the side face of the stator tooth 6 adjoining the stator yoke 10 and the stator winding 8.

The insulating coating 7 can be a coating that can be applied to the areas to be coated in a continuous layer, for example in an automated process. The coating can be applied, for example, via lacquering or fluidized bed sintering.

Furthermore, the insulating coating 7 can be applied via overmolding the stator in a tool, in particular by transfer molding or injection molding.

The insulating coating 7 is preferably applied directly to the areas of the stator to be coated, so that the insulating coating 7 is firmly connected to the areas of the stator to be coated, creating a mechanical and thermal connection between the insulating coating 7 and surfaces of the areas of the stator to be coated.

It can be seen from the above explanations that an insulating coating 7 is provided between the stator winding 8 and the stator 2, 5 in an electric machine, preferably an axial flux machine, of any design. The main function of the insulating coating 7 is to implement an additional second insulating measure that effectively electrically insulates the electrical conductor insulated with the insulating layer in the event of a fault in the insulating layer of the electrical conductor, i.e., a winding insulation, from the stator and adjacent electrically conductive components. The insulating coating 7 covers or envelops with a sufficient thickness the areas in which clearance and creepage distances are not reached in the event of a fault in the winding insulation. Areas include, but are not limited to, surfaces of the stator tooth, the stator yoke, and generally adjacent and near to surfaces of electrically conductive components.

The stator body is exposed locally to accommodate the insulating coating 7, so that the insulating coating does not increase the dimensions of the electromagnetically active components or increases them only slightly or only locally in relation to a mechanical air gap of the machine.

Although the present disclosure has been described above in terms of embodiments, it is to be understood that various modifications and changes can be made without departing from the scope of the present disclosure as defined in the appended claims.

With regard to further features and advantages of the present disclosure, reference is expressly made to the disclosure of the drawing.

### LIST OF REFERENCE SIGNS

1 Electric axial flux machine
2 First stator
3 Stator body with stator winding
4 Rotor
5 Second stator
6 Stator tooth
7 Insulating coating
8 Stator winding
9 Housing
10 Stator yoke
11 Local depression
12 Main axis
13 Axial direction
14 Air gap
15 Spacing element

1. An electric machine comprising: a stator, a rotor and an air gap located between the stator and the rotor, wherein
the stator has:
a stator body;
a stator winding;
an insulating coating arranged between the stator winding and the stator body for providing electric insulation between the stator winding and the stator body; and
a local depression provided in the stator body,
wherein the insulating coating is arranged in the local depression, and the local depression is arranged on a side of the stator body facing the air gap.

2. The electric machine according to claim 1, wherein the insulating coating is arranged exclusively in the local depression on a side of the stator body facing the air gap.

3. The electric machine according to claim 1, wherein the electric machine is an electric axial flux machine and the stator and the rotor with the air gap located in between are arranged coaxially to one another in a direction axial to a main axis of the electric axial flux machine.

4. The electric machine according to claim 3, wherein the local depression is formed such that, in the direction axial to the main axis, a common height of the stator body and the insulating coating arranged in the local depression is less than or equal to a height of the stator body outside a region of the local depression.

5. The electric machine according to claim 1, wherein
the stator body has a stator tooth and a stator yoke, and
the local depression is provided in the stator tooth.

6. The electric machine according to claim 5, wherein the insulating coating is provided on the stator yoke on a side of the stator yoke facing the air gap.

7. The electric machine according to claim 1, wherein the insulating coating is arranged directly on the stator.

8. The electric machine according to claim 5, wherein the insulating coating is provided on a side face of the stator tooth adjoining the stator yoke.

9. The electric machine according to claim 8, wherein between the insulating coating provided on the side face of the stator tooth adjoining the stator yoke (10) and the stator winding a spacer element is provided for forming a cooling channel between the insulating coating and the stator winding.

10. The electric machine according to claim 1, wherein the insulating coating is at least one of a lacquer, a fluidized bed sinter or an overmold coating.

11. A stator for an electric machine comprising:
a stator body;
a stator winding;
an insulating coating arranged between the stator winding and the stator body for providing electric insulation between the stator winding and the stator body; and
a local depression provided in the stator body,
wherein the insulating coating is arranged in the local depression.

12. The stator according to claim 11, wherein the insulating coating is arranged exclusively in the local depression.

13. The stator according to claim 11, wherein the local depression is formed such that, in a direction axial to a main axis, a common height of the stator body and the insulating coating arranged in the local depression is less than or equal to a height of the stator body outside a region of the local depression.

14. The stator according to claim 11, wherein the stator body has a stator tooth and a stator yoke, and the local depression is provided in the stator tooth.

15. The stator according to claim 14, wherein the insulating coating is provided on the stator yoke on a side of the stator yoke.

16. The stator according to claim 15, wherein the insulating coating is arranged directly on the stator.

17. The stator according to claim 16, wherein the insulating coating is provided on a side face of the stator tooth adjoining the stator yoke.

18. The stator according to claim 17, wherein between the insulating coating provided on the side face of the stator tooth adjoining the stator yoke and the stator winding a spacer element is provided for forming a cooling channel between the insulating coating and the stator winding.

19. The stator according to claim 11, wherein the insulating coating is at least one of a lacquer, a fluidized bed sinter or an overmold coating.
